(19) United States
(12) Patent Application Publication
(10) Pub. No.: US 2008/0111064 A1
(43) Pub. Date: May 15, 2008

(54) DOWNHOLE MEASUREMENT OF SUBSTANCES IN EARTH FORMATIONS

(75) Inventors: Albert Ballard Andrews, Wilton, CT (US); Jeffrey A. Tarvin, Boston, MA (US); Kenneth E. Stephenson, Belmont, MA (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Ridgefield, CT (US)

(21) Appl. No.: 11/558,648

(22) Filed: Nov. 10, 2006

(51) Int. Cl. G01V 5/08

(52) U.S. Cl. 250/269.1; 356/301

(57) ABSTRACT

A method for determining a property of earth formations surrounding a borehole, including the following steps: isolating a region of the borehole, and obtaining a sample of borehole fluid from the isolated region; and implementing measurements, dowhole, of the Raman scattering of electromagnetic energy directed at the fluid sample; the property of the earth formations being determinable from the measurements. In a disclosed embodiment, the steps of isolating a region of the borehole and obtaining a sample of borehole fluid from the isolated region include: providing a logging device in the borehole in sealing engagement with the isolated region, causing formation fluid from the isolated region to flow in a flow line of the logging device, and providing a measurement cell in the logging device which receives the sample of formation fluid via the flow line.

### RELATED APPLICATION

The subject matter of the present Application is related to subject matter in co-pending U.S. patent application Ser. No. ______, (File 60.1628, K. Stephenson and J. Tarvin), filed of even date herewith, and assigned to the same assignee as the present Application.

### FIELD OF THE INVENTION

The invention relates to the downhole measurement of substances in formations surrounding an earth borehole.

### BACKGROUND OF THE INVENTION

Existing well logging devices can provide useful information about hydraulic properties of formations, such as pressures and fluid flow rates, and can also obtain formation fluid samples for downhole analysis or subsequent uphole analysis. Reference can be made, for example, to U.S. Pat. Nos. 3,859,851, 3,789,575, 3,934,468, and 4,860,581. In a logging device of this general type, known as a formation testing device, a setting arm or setting pistons can be used to controllably urge the body of the logging device against a side of the borehole at a selected depth. The side of the device that is urged against the borehole wall typically includes a packer which surrounds a probe. As the setting arm extends, the probe is inserted into the formation, and the packer then sets the probe in position and forms a seal around the probe, whereupon formation pressure can be measured and fluids can be withdrawn from the formation. A formation testing device in widespread commercial use is the “MDT” (trademark of Schlumberger).

Techniques were developed for determining substances in fluids of a flow line of a formation testing device such as the MDT. In one technique, the fluid is passed through a chamber in the flow line, a light source, for example an infrared source, is directed at the chamber, and a spectral detector detects the spectrum of transmitted and/or backscattered or reflected light. These and other techniques have been used and extended to obtain gas oil ratio (“GOR”) and various types of compositional information. Reference can be made, for example, to U.S. Pat. Nos. 5,589,430, 5,939,717, 6,465,775, and 6,476,384, and to Badry et al., “Downhole Optical Analysis of Formation Fluids,” Oilfield Review, pp. 21-28, January, 1994.

A limitation when measuring hydrocarbon vibrational bands using infrared absorption is that there are strong water peaks both in the near IR (1445 nm, 2000 nm) and mid IR. Quantitative measurement is inaccurate or impossible if there is a high water cut unless the water is first removed from the fluid by a separator or equivalent device. Another limitation is that the hydrocarbon overtones in the near IR are essentially identical for a wide range of oils, so that useful compositional information is obtained only for condensates while volatiles, black oils and heavy oils are distinguishable only by their color. Another problem is that the CO₂ band at 2008 nm, is relatively weak compared to the fundamental. Another shortcoming is that some chemical species do not have any vibrational bands in the visible or near I R where these spectrometers operate, for example H₂S. For these and other reasons, there is a need for a complementary spectroscopic technique for logging in wells where the accuracy of infrared absorption may be limited or problematic.

Although it has previously been suggested that Raman spectroscopy be used for making certain measurements on formations surrounding earth boreholes, prior art approaches have certain limitations and/or drawbacks. For example, prior techniques attempt to perform measurements on formation fluids that are subject to mixing and contamination with borehole fluids and/or fluids from other formation regions. Also, previously proposed Raman scattering measurement techniques may require equipment configurations that are unduly complex and/or expensive, and are not readily compatible with existing equipment.

It is among the objects of the present invention to provide an improved method and apparatus for downhole determination of properties of sampled borehole fluids, which overcome drawbacks and limitations of prior art approaches.

### SUMMARY OF THE INVENTION

Raman spectroscopy provides a valuable complement to infrared absorption spectroscopy, especially in cases where the absorption bands of species in a complex mixture overlap with the solute matrix and this interference precludes quantitative species identification or compositional analysis. The Table of FIG. 6 provides a partial list of some prominent Raman bands for typical species expected if natural gas is dissolved in a water matrix. In more complex mixtures or in solids, the precise band position will depend on the chemical bonds. It can be readily seen that in nearly every case, the Raman peaks associated with small molecules are well separated from each other. In particular, methane, carbon dioxide and hydrogen sulfide do not overlap with each other or with water.

Raman spectroscopy has not generally been the method of choice for determining the content of hydrocarbon mixtures. This is due in part to the strong fluorescence that occurs when visible laser excitation wavelengths are used. Since the development of FT-IR Raman spectrometers, however, quantitative Raman analysis of complex mixtures such as fuel oils and natural gas, have been reported (see, for example, U.S. Pat. Nos. 4,802,761, 5,139,334, 6,590,647 and 6,678,050). Another difficulty with Raman spectroscopy is that the signal is relatively weak because only about one in a million source photons will undergo Raman scattering. There are a number of techniques available, however, for enhancing the Raman signal including Resonance Raman Scattering (RRS), Surface Enhanced Raman Scattering (SERS) and Surface Enhanced Resonance Raman Scattering (SERRS) and Coherent Anti-Stokes Raman Scattering (CARS), and one or more of these techniques can be utilized in embodiments hereof.

In accordance with an embodiment of the invention, a method is set forth for determining a property of earth formations surrounding a borehole, including the following steps: isolating a region of the borehole, and obtaining a sample of borehole fluid from the isolated region; and implementing measurements, dowhole, of the Raman scattering of electromagnetic energy directed at the fluid sample; said property of the earth formations being determinable from said measurements. In one preferred form of this embodiment, the steps of isolating a region of the borehole and obtaining a sample of borehole fluid from the isolated region include: providing a logging device in the borehole in sealing engagement with the isolated region, causing formation fluid from the isolated region to flow in a flow line of the logging device, and providing a measurement cell in the logging device which receives said sample of formation fluid via the flow line. In this embodiment, the step of implementing measurements, downhole, of electromagnetic energy directed at the fluid sample, comprises: directing a light beam at the sample and detecting Raman scattering of said light from the sample to obtain said measurements.

In an embodiment of the invention, the property to be determined comprises the presence and/or concentration of a substance selected from the group consisting of hydrocarbon species, carbon dioxide, and hydrogen sulfide.

In an embodiment of the invention, the steps of directing a light beam at the sample and detecting Raman scattering of the light from the sample includes discriminating against fluorescence in the detecting of Raman scattering. In a preferred form of this embodiment, the step of discriminating against fluorescence in the detecting of Raman scattering includes pulsing the light beam and gating the detector.

In an embodiment of the invention, the step of directing a light beam at the sample and detecting Raman scattering of light from the sample comprises providing a laser diode for producing a laser beam directed at said sample, and providing a detector array to detect Raman scattering of said light. In a form of this embodiment, there is further provided a first fiber optical link coupled between the laser diode and the sample, and a second fiber optical link between the sample and the detector array. In a form of this embodiment, the step of providing a detector array to detect Raman scattering of light further comprises providing a diffraction grating in the path of Raman scattered light detected by the detector array.

Further features and advantages of the invention will become more readily apparent from the following detailed description when taken in conjunction with the accompanying drawings.

### BRIEF DESCRIPTION OF THE DRAWINGS

FIG. 1 is a diagram, partially in block form, of an apparatus in which embodiments of the invention can be employed, and which can be used in practicing embodiments of the invention.

FIG. 2 is a diagram of a flow line of the FIG. 1 device, the flow line containing formation fluids, and of equipment of a type that has been utilized in the prior art to obtain measurements regarding formation fluids.

FIG. 3 is a diagram, partially in block form, of an apparatus in accordance with an embodiment of the invention and which can be used in practicing embodiments of the method of the invention.

FIG. 4 is a diagram, partially in block form, of an apparatus in accordance with another embodiment of the invention and which can be used in practicing embodiments of the method of the invention.

FIG. 5 shows graphs of Raman scattering spectra of a number of substances at different pressures.

FIG. 6 is a Table showing the wavelengths of Raman band peaks for a number of substances.

### DETAILED DESCRIPTION

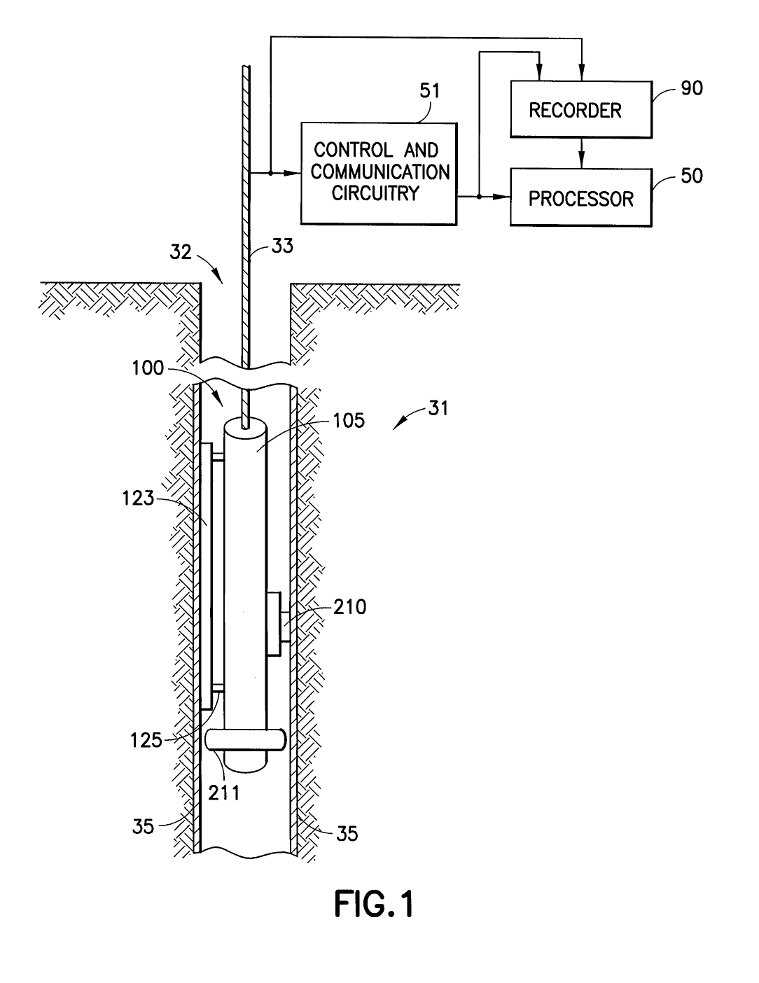

Referring to FIG. 1 there is shown a representative embodiment of a so-called “formation testing” apparatus for investigating subsurface formations 31 traversed by a borehole 32, of a type which, when modified as described herein, can be used in practicing embodiments of the invention. Formation testing logging devices are described, for example, in the above-referenced U.S. Pat. Nos. 3,859,851, 3,789,575, 3,934,468 and 4,860,581, and in Badry et al., “Downhole Optical Analysis of Formation Fluids,” Oilfield Review, pp. 21-28, January, 1994. The borehole 32 is typically filled with drilling fluid or mud which contains finely divided solids in suspension. A mudcake on the borehole wall is represented at 35. The investigating apparatus or logging device 100 is suspended in the borehole 32 on an armored multiconductor cable 33, the length of which substantially determines the depth of the device 100. Known depth gauge apparatus (not shown) is provided to measure cable displacement over a sheave wheel (not shown) and thus the depth of logging device 100 in the borehole 32. The cable length is controlled by suitable means at the surface such as a drum and winch mechanism (not shown). Circuitry 51, shown at the surface although portions thereof may typically be downhole, represents control and communication circuitry for the logging apparatus. Also shown at the surface are processor 50 and recorder 90. These may all generally be of known type. Although the control and processing associated with embodiments hereof will be performed by downhole and uphole processors of the illustrated equipment, it will be understood that parts of the processing may be performed at locations remote from the borehole, which may be in direct or indirect communication with the wellsite. Also, while preferred embodiments hereof are described in the context of wireline logging equipment, it will be understood that the invention may also have application to logging while drilling, tripping, and/or pausing, or other investigation in an earth borehole.

The logging device or tool 100 has an elongated body 105 which encloses the downhole portion of the device, controls, chambers, measurement apparatus, etc. One or more arms 123 can be mounted on pistons 125 which extend, e.g. under control from the surface, to set the tool. One or more packer modules are represented by the reference numeral 211. The logging device includes one or more probe modules each of which includes a probe assembly 210 which is movable with a probe actuator (not separately shown) and includes a probe (not separately shown) that is outwardly displaced into contact with the borehole wall, piercing the mudcake and communicating with the formations, and a packer for hydraulic isolation. The equipment and methods for taking pressure measurements and doing sampling are well known in the art, and the logging device 100 is provided with these known capabilities. Reference can be made, for example, to the above-referenced patents and publication.

Modern commercially available well logging services utilize, for example, a form of a formation tester tool called the modular formation dynamics tester (“MDT”—trademark of Schlumberger), of the general type described in the above-referenced Badry et al. publication, which can provide a variety of measurements and samples, as the tool is modularized and can be configured in a number of ways. Examples of some of the modules employed in this type of tool, are as follows: An electric power module is generally provided, and is typically, but not necessarily the first (top) module in the string. A hydraulic power module provides hydraulic power to all modules that may require same, and such power can be propagated via a hydraulic bus. Probe modules, which can be single or plural probes, includes pistons for causing engagement of probe(s) for fluid communication with the formations. Sample modules contain sample chambers for collecting samples of formation fluids, and can be directly connected with sampling points or connected via a flowline. A pumpout module can be used for purging unwanted fluids. An analyzer module uses optical analysis to identify certain characteristics of fluids. A packer module includes inflatable packer elements which can seal the borehole circumference over the length of the packer elements. Using the foregoing and other types of modules, the tool can be configured to perform various types of functions. Embodiments of the present invention have application to tool configurations which draw formation fluid into the tool, the tool having a flow line in which the fluid is contained and can flow.

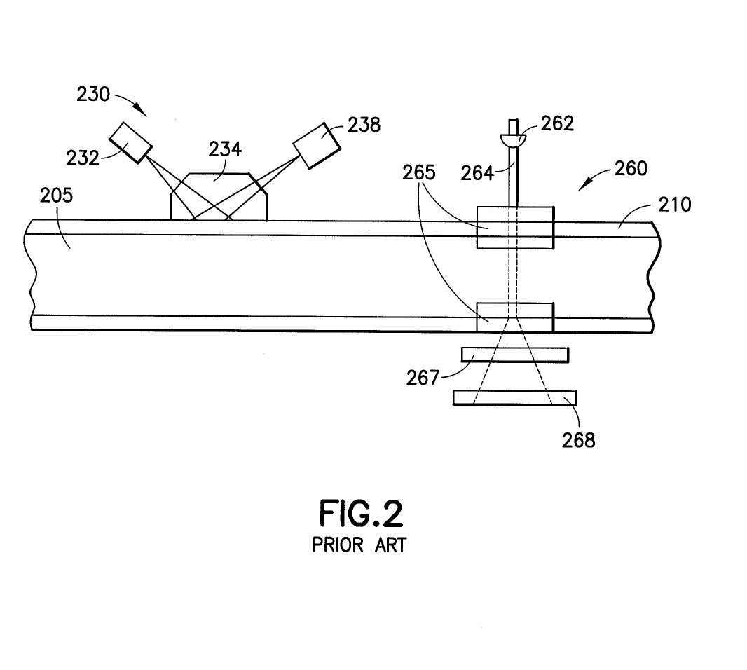

FIG. 2 shows a flow line 210 of the FIG. 1 device containing formation fluid 205. As described, for example, in Badry et al., supra, two sensor subsystems are provided; subsystem 260 for liquid detection and analysis, and subsystem 230 for gas detection. In subsystem 260, absorption spectroscopy is used to detect and analyze liquid. A light source, such as lamp 262, directs a beam of light 264 through sapphire window 265 and the fluid 205 in the flow line 210 and the exiting beam is distributed by spectral distributor 267 and detected by an array 268 of photodiode detectors which are tuned to different wavelengths. In this manner, the absorption spectrum of the fluid is determined. As described in Badry et al., supra, water absorbs very little light in the visible region. This continues at the shorter wavelengths in the near infrared region until a resonance in the molecular vibration of the oxygen-hydrogen [O—H] bond causes a sudden increase in absorption forming a peak near 1450 nanometers (nm). Another resonance in the O—H bond causes a second, much stronger, peak near 2000 nm. For oils, molecular vibration absorption peaks at 1700 nm, caused by a resonance vibration in the C—H bond. The uniqueness and separation of these peaks permit differentiation of oil and water. Color provides another parameter for liquid identification.

In subsystem 230, light from a light-emitting diode 232 is polarized by a polarizer (not separately shown), focused by a lens (not separately shown), and spread over a range of incident angles by a sapphire prism 234 which is also a window on flow line 210. A detector array 238 measures the reflection intensity over angles from just below the Brewster angle for air to just below the critical angle for water. As described in Badry et al., supra, since values for the Brewster and critical angles differ significantly between gases and liquids, measuring the relative intensity of the reflected light over a range of angles permits positive identification of gas. Using both angles is desirable to detect gas in the presence of liquids.

An embodiment of the present invention utilizes Raman spectroscopy which, inter alia, provides a valuable complement to infrared absorption spectroscopy. The intensity of Raman scattered light from a sample is given by:

I(v)=(0.0395*π³/c⁴)[hIN(vₒ−v)⁴]/[μv(1−e^{-hv/kT})]*[45α²+7γ²] (1)

where
I=The excitation intensity
N=Number of scattering molecules
   v=The molecular vibrational frequency
vₒ=Laser excitation frequency
μ=Reduced mass of the vibrating atoms
α=Mean value invariant of the polarizability tensor
γ=Anisotropy invariant of the polarizability tensor

Equation (1) forms the basis for most quantitative analysis using Raman spectroscopy. The proportional relationship between the scattering intensity and the analyte concentration provides a metric that can be used to construct an analytical model of a set of Raman spectra. An analytical model may be attempted from first principles using Equation (1), but this is difficult in practice because the absolute Raman cross-sections and collection efficiency in general are not known. Instead, in a preferred form hereof, an analytical model can be constructed by first measuring the Raman spectra of known samples that have been analyzed by other means such as gas chromatography or infrared absorption. The accuracy of the model can then be tested on a validation set. Together with an appropriate calibration procedure this can provide compositional information and GOR in a way that is similar to that of the infrared absorption techniques described, for example, in the referenced in U.S. Pat. Nos. 6,476,384, 6,465,775, 5,859,430 and 5,939,717, and in Badry et al., supra. This procedure need not be redundant, since the Raman analysis can extend beyond the admissible range of the other techniques.

Analysis of sample composition using Raman spectra is generally based on the band area and the principle of linear superposition, which states that the Raman spectrum of a mixture is equal to the weighted sum of the individual species in the mixture. The relative cross sections of a large number of gases have been tabulated (see, for example, U.S. Pat. No. 5,684,580). In a complex mixture, the Raman spectrum will be broadened by the superposition of the overlapping species. The individual peaks may or may not be resolved; however, a change in the relative concentrations of one or more of the species present will cause a change in either the Raman band position or shape. Chemical interactions between sample species can modify the Raman spectra and change the position of the band. Consequently, changes in the relative sample concentrations can be empirically related, through a calibration procedure, to changes in the sample. The band position can also provide information about the phase of the sample.

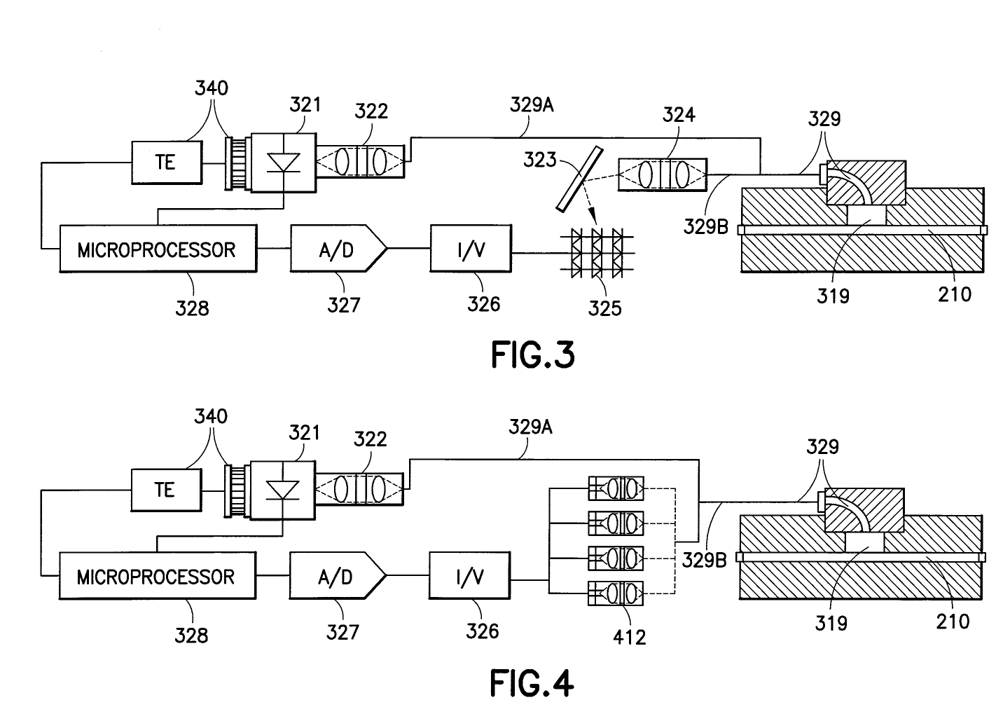

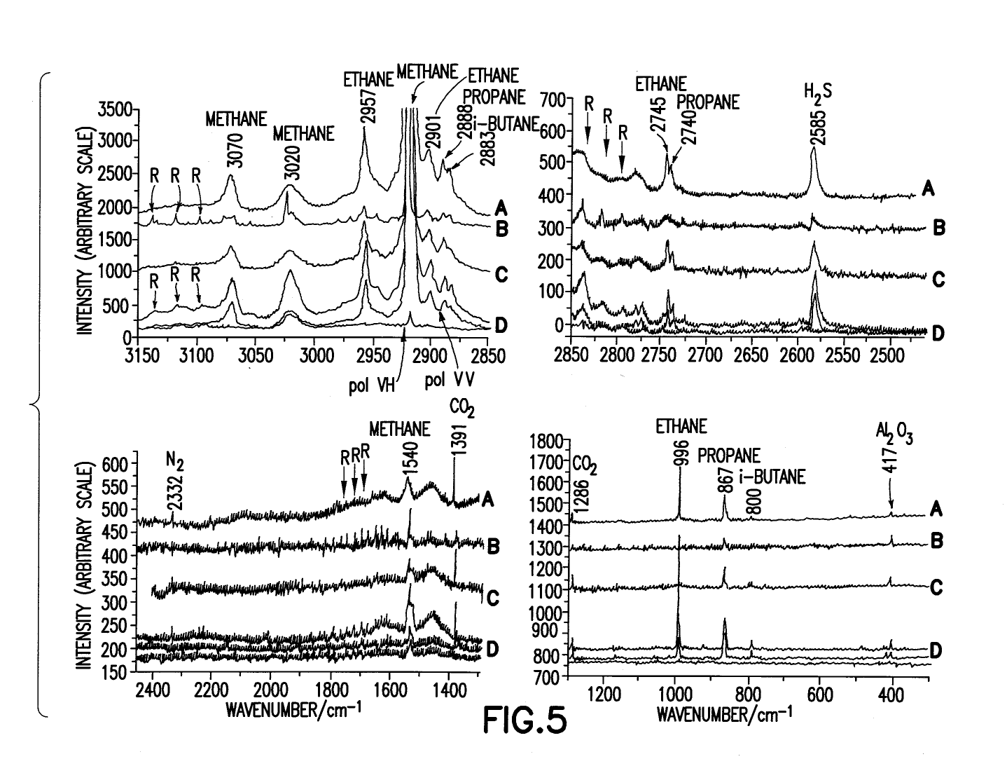

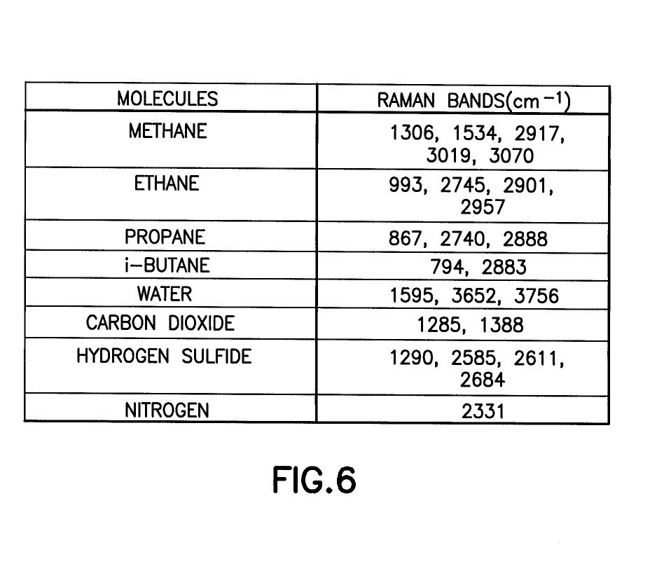

Referring to FIGS. 3 and 4, there are shown diagrams of equipment in the logging device 100 of FIG. 1 that is in accordance with an embodiment of the invention. In these diagrams, 210 represents the flow line of a formation testing type of logging device, as in FIGS. 1 and 2, it being understood that the invention has application to other logging devices. A pressure sealed window 319, for example a sapphire window, is provided, and a fiber optical link 329 couples electromagnetic radiation which, in this embodiment is light from a laser diode source 321, via optics 322, to the window and flow line. In the simplified diagrams of FIGS. 3 and 4, part of the fiber optics link or bundle 329 is represented by branches 329A and 329B. Light scattered back toward the divided fiber bundle 329 is coupled, via fiber optics branch 329B and optics 324, to a detector 325 (FIG. 3) which, in one embodiment, is a CCD detector.

The detector 325 is coupled to microprocessor 328 via current-to-voltage converter 326 and analog-to-digital converter 327. The microprocessor 328 controls the operation of laser diode 321 and the thermoelectric device 340. Power is provided by a power supply in the logging device (not separately shown).

In some cases, fluorescence from the liquid sample may be intense enough to mask the Raman scattering. In such cases, one can discriminate against the fluorescence with a pulsed laser 321 and a gated detector 325. Raman scattering is an instantaneous event, whereas fluorescence results from the decay of excited molecular states. When the decay takes more than a few nanoseconds, a laser-detector combination that measures for a few nanoseconds or less captures all available Raman scattering, but only a fraction of fluorescent emission. Therefore, to discriminate against fluorescence, a form of this embodiment uses a pulsed pump and a gated detector. An interference filter and focusing optics are preferably employed. The laser diode source 321 can be a tunable laser diode. Since the laser diode may not operate properly in the ambient temperatures encountered in the borehole, it is cooled with a thermoelectric device 340 or other cooling device suitable for conditions in the borehole. The optics 322 preferably includes a band rejection filter and focusing optics. In the embodiment of FIG. 3, the scattered light is analyzed through dispersive grating 323 coupled to the CCD detector 325. The CCD detector can also be cooled (by a cooling device not shown) to minimize thermal noise contributing to the signal being detected.

In the embodiment of FIG. 4, the Raman spectrum is analyzed using bandpass filters 412 that have been selected to match the Raman bands of the analyte(s). In this embodiment, each filter selects a different Raman band and has a detector which is optimally selected for a given wavelength. In this embodiment, the use of filters in lieu of diffraction gratings is equivalent to integrating the signal produced by the latter over a narrow window of the spectrum.

Methods for extracting a relationship between the concentrations of an analyte and a metric extracted from the Raman spectrum are familiar to those skilled in the art. In some cases, the concentration of an analyte may determined from the area of a single Raman band. This relationship may be of a linear kind, using an internal standard for which the concentration does not change when the analyte changes, or in other cases there may be a non-linear relationship between the analyte concentration and the internal standard. For example, consider a pure analyte Raman spectrum that is multiplied by a constant. When the resulting product is subtracted from the sample spectrum the contribution from the analyte is eliminated. The value of the constant is then proportional to the analyte's concentration. If the true species concentration is known, the uncertainty in the concentration can be estimated from the root mean square error of prediction (RMSEP) which is given by:

RMSEP=sqrt{Σⁿᵢ₌₁(cᵢ−ĉᵢ)²/n} (2)

where
n=the number of samples in the validation set
cᵢ=the true species concentration
cᵢ̂=the calculated concentration of the species

In most cases quantitative analysis will require the use of more than one Raman band. Again, as in the previous case, an analytical model can be created by measuring the Raman spectra of samples whose concentrations are known from some other means of analysis such as gas chromatography. The desired property may then be empirically related to the Raman band areas. Testing on other known samples using statistical methods can validate the accuracy of the analytical model. Embodiments hereof can employ the techniques of multivariate analysis to make a prediction of the concentrations. These methods, which are known to those skilled in the art, include, but are not limited to, Least Squares (LS) in which a linear combination of spectra from the pure components can be used to produce the best fit to the measured sample spectra and the multiplicative constants used in the fit are proportional to the concentrations of the respective components. In the event that the pure spectra are changed when the components are mixed together, the Raman spectra of the pure sample may be estimated from the Raman spectrum of the mixture. Analysis of the Raman spectrum of a complex mixture of hydrocarbons can be facilitated by the use of inverse methods that reduce the size of the training set and compress the spectra without loss of information. These methods include, but are not limited to, Partial Least Squares (PLS), Principal Components Analysis (PCA), or Multiple Linear Regressions (MLS).

FIG. 5 show graphs of Raman scattering spectra of a number of substances at different pressures; namely, A=10.2 MPa, B=1.1 MPa, C=8.0 MPa and D=6.4 MPa. Raman bands tend to be well resolved from one another, and signal intensities may only occupy a small portion of the total Raman spectrum. Hence, if the analyte spectrum is known beforehand from pre-calibration studies, it is possible to select limited regions of the Raman spectrum and thereby accelerate quantitative analysis of the spectra. In an embodiment of the invention, described, a CCD detector is coupled to a dispersive grating to rapidly analyze a wide spectral range. It is preferable to use techniques that enhance the Raman signal to compensate for the weak scattering cross section. In RRS or SERRS, the wavelength of the exciting light is chosen to coincide with an absorption band of the analyte so that it is enhanced over the other components in the mixture. In the laboratory, with a tunable laser source, this permits selective enhancement of individual components in the mixture. However, this technique is difficult to implement in a downhole environment because of the increased complexity of the optics. Therefore, an embodiment hereof uses a method of enhancement described in U.S. Pat. No. 6,590,647. In this method, gold nanoparticles are embedded into a porous glass matrix at the end of an optical fiber or into the fiber itself. The nanoparticles are tuned to have “surface plasmon resonance” (in which incident light is converted strongly into electron currents at the metal surface) that optimizes the production of Raman emission relative to the incident light.

Embodiments of the invention may be combined with other optical probes such as an infrared spectrometer or fluorescence detector and an interpretation developed by cross-correlating the logs. For example, Raman measurements may be used to supplement, refine or extend the interpretation the infrared spectroscopy data. As an example, suppose that GOR is needed in a well where there is a high water cut. Visible absorption spectroscopy will yield qualitative information about the color of the oil from the scattering which is proportional to the concentration of aromatics, however in the near infrared, water bands (1445, 2000 nm) would obscure the hydrocarbon bands (1650-1760 nm). The Raman band of methane, (2719 cm⁻¹) could then be used to determine GOR.

In the case of CO₂ or H₂S, infrared spectroscopy may be combined with Raman spectroscopy to provide concentration information for these species in the following manner. Suppose that the methane concentration has already been determined by infrared analysis or some other means. The methane Raman located at 2917 cm⁻¹ (3428 nm) may be used. The molar concentrations of the band area is determined from the Raman spectra, e.g. the prominent v₁ band other components such as CO₂ or H₂S may be determined from the Relative Normalized Differential Cross Section (RNDRS) using Equation 3:

$${C}_{x} = {C}_{CH 4} * \frac{{A}_{x ( {v}_{x} )} * {\sum }_{CH 4 ( {v}_{1} )}}{{A}_{CH 4 ( {v}_{1} )} * {\sum }_{x ( {v}_{x} )}} \qquad ( 3 )$$

where
Cₓ=mole fraction of component x in the gas
C_{CH4}=mole fraction of methane known from GC
Σₓ(vₓ)=RNDRS relative to N₂ for component x at wavenumber vₓ
Σ_{CH4}(v₁)=RNDRS for CH₄ relative to N₂wavenumber at v₁=2917 cm⁻¹ (3428 nm)
Aₓ(vₓ)=Area of band at wavenumber vₓ for component x
A_{CH4}(v₁)=Area of band at wavenumber v₁ for methane

The invention has been described with reference to particular preferred embodiments, but variations within the spirit and scope of the invention will occur to those skilled in the art. For example, it will be understood that other circuit configurations can be utilized to process the Raman scattering signals.

1. A method for determining a property of earth formations surrounding a borehole, comprising the steps of:
isolating a region of the borehole, and obtaining a sample of borehole fluid from the isolated region; and
implementing measurements, of the Raman scattering of electromagnetic energy directed at the fluid sample;
said property of the earth formations being determinable from said measurements.

2. The method as defined by claim 1, wherein said steps of isolating a region of the borehole and obtaining a sample of borehole fluid from the isolated region comprise: providing a logging device in the borehole in sealing engagement with the isolated region, causing formation fluid from the isolated region to flow in a flow line of said logging device, and providing a measurement cell in said logging device which receives said sample of formation fluid via said flow line.

3. The method as defined by claim 1, wherein said step of implementing measurements, downhole, of electromagnetic energy directed at the fluid sample, comprises: directing a light beam at said sample and detecting Raman scattering of said light from the sample to obtain said measurements.

4. The method as defined by claim 2, wherein said step of implementing measurements, downhole, of electromagnetic energy directed at the fluid sample, comprises: directing a light beam at said sample and detecting Raman scattering of said light from the sample to obtain said measurements.

5. The method as defined by claim 2, wherein said property comprises the presence of a substance selected from the group consisting of hydrocarbon species, carbon dioxide, and hydrogen sulfide.

6. The method as defined by claim 2, wherein said property comprises the concentration of a substance selected from the group consisting of hydrocarbon species, carbon dioxide, and hydrogen sulfide.

7. The method as defined by claim 4, wherein said steps of directing a light beam at said sample and detecting Raman scattering of the light from said sample includes discriminating against fluorescence in the detecting of Raman scattering.

8. The method as defined by claim 7, wherein said step of discriminating against fluorescence in the detecting of Raman scattering includes pulsing said light beam and gating said detector.

9. The method as defined by claim 4, wherein said step of directing a light beam at said sample and detecting Raman scattering of said light from the sample comprises providing a laser diode for producing a laser beam directed at said sample, and providing a detector array to detect Raman scattering of said light.

10. The method as defined by claim 9, further comprising providing a first fiber optical link coupled between said laser diode and said sample, and providing a second fiber optical link between said sample and said detector array.

11. The method as defined by claim 9, further comprising providing the step of thermoelectric cooling for said laser diode.

12. The method as defined by claim 9, wherein said step of providing a detector array to detect Raman scattering of said light further comprises providing a diffraction grating in the path of Raman scattered light detected by said detector array.

13. The method as defined by claim 2, wherein said measurements of Raman scattering are measurements of enhanced Raman scattering.

14. The method as defined by claim 1, wherein said method is implemented with a logging device suspended in the borehole on a wireline.

15. The method as defined by claim 1, wherein said method is implemented with a logging tool on a drill string.

16. The method as defined by claim 1, further comprising the step of determining said property of the earth formations from said measurements; and wherein at least a part of said step of determining said property is performed.

17. The method as defined by claim 1, further comprising the step of determining said property of the earth formations from said measurements; and wherein at least a part of said step of determining said property is performed uphole.

18. The method as defined by claim 3, further comprising performing said method at a number of different depth levels in the borehole and forming a log of said measurements.

19. Apparatus for determining a property of earth formations surrounding a borehole, comprising:
a logging device in the borehole adapted for sealing engagement with an isolated region of the borehole;
a flow line in said device for receiving formation fluid;
a measurement cell in said logging device which receives said sample of formation fluid via said flow line;
a laser source for directing a light beam at said measurement cell; and
a detector for obtaining measurements of Raman scattering of said light from the sample;
said property of the earth formations being determinable from said measurements.

20. Apparatus defined by claim 19, wherein said property comprises the presence of a substance selected from the group consisting of hydrocarbon species, carbon dioxide, and hydrogen sulfide.

21. Apparatus as defined by claim 19, wherein said property comprises the concentration of a substance selected from the group consisting of hydrocarbon species, carbon dioxide, and hydrogen sulfide.

22. Apparatus as defined by claim 19, wherein said laser source comprises a pulsed laser diode, and said detector comprises a gated detector for discriminating against fluorescence in the detecting of Raman scattering.

23. Apparatus as defined by claim 19, further comprising a first fiber optical link coupled between said laser source and a window of said measurement cell, and a second fiber optical link between said window and said detector.

24. Apparatus as defined by claim 22, further comprising providing a thermoelectric device in said logging device for cooling for said laser diode.

25. Apparatus as defined by claim 22, wherein said detector comprises a detector array and further comprising a diffraction grating in the path of Raman scattered light detected by said detector array.

26. Apparatus as defined by claim 22, wherein said detector comprises a bank of filters, each having an associated detector.
